(19) United States
(12) Patent Application Publication
(10) Pub. No.: US 2009/0245143 A1
(43) Pub. Date: Oct. 1, 2009

(54) CONFERENCE SYSTEM, CONFERENCE PROGRAM, AND CONFERENCE RESOURCE ALLOCATION METHOD

(75) Inventors: Mari Hamachi, Fukuoka (JP); Yasuo Inoue, Fukuoka (JP); Masatoshi Kaneko, Amakusa (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/411,839

(22) Filed: Mar. 26, 2009

(30) Foreign Application Priority Data
Mar. 27, 2008 (JP) 2008-084388

(51) Int. Cl. H04Q 11/00

(52) U.S. Cl. 370/261

(57) ABSTRACT

Conference system includes a conference status recording unit recording an identifier of a conference using allocated resources and a usefulness value indicating the degree of usefulness of the conference. A request accepting unit accepts a conference start request from a user. A conference opening unit instructs a multipoint connection apparatus to secure resources for use in the requested conference and records an identifier of the conference to be started and an initial usefulness value of the conference in the conference status recording unit. A resource releasing unit, when there are no available resources necessary for the new conference accepted, selects another open conference, of which resources may be released, based on the usefulness value of the other open conference recorded in the conference status recording unit, and instructs the multipoint connection apparatus to release the resources allocated to the selected open conference.

### CROSS-REFERENCE TO RELATED APPLICATIONS

This application is based upon and claims the benefit of priority of the prior Japanese Patent Application No. 2008-84388, filed on Mar. 27, 2008, the entire contents of which are incorporated herein by reference.

### BACKGROUND

1. Field of the Invention

The embodiment relates to a conference system, conference program and conference resource allocation method that allocate resources, which enable a conference through data communications, including audio, among a plurality of terminals, to each conference.

2. Description of the Related Art

A conference through communications among a plurality of communication terminals starts in such a manner that the plurality of communication terminals establishes a session or call one another through a conference server, a PBX, or the like. Then, resources are secured in use for the conference. Here, the resources are, for example, a functional unit that enables communications among the plurality of communication terminals in such a manner that hardware, such as a multipoint connection apparatus, is controlled by software and/or hardware. Then, a communication terminal requests the conference server or the PBX to release the call or the session to close the conference. Then, the resources secured for the conference are released.

In a conference system that is operated using finite resources, resources for conference are wastefully used frequently. For example, a terminal of a third person who is not concerned in a conference may possibly be used to open the conference for securement of resources and then left as it is without releasing the resources. In addition, a user who frequently opens a conference may start a conference and then leave securement of resources (does not release resources) intentionally. In this way, when resources for conference are wastefully used, it may interfere with opening of a new conference.

For the above, a line control apparatus has been suggested, which disconnects a communication line if both a transmission audio monitoring unit and a reception audio monitoring unit do not detect an input for a predetermined period of time (see, for example, Japanese Unexamined Patent Application Publication No. 9-289551). In addition, a communication conference terminal apparatus has been suggested, which ends a communication operation after outputting an advance notice audio guidance message for disconnection when a duration during which an audio level higher than or equal to a predetermined value is not detected is longer than or equal to a predetermined period of time (see, for example, Japanese Unexamined Patent Application Publication No. 8-125781).

### SUMMARY

A conference system disclosed in the application allocates resources of a multipoint connection apparatus, having a function of combining communication signals including audio of a plurality of terminals and transmitting the combined communication signals to each of the plurality of terminals, to each conference through communications of a plurality of user desired terminals. The conference system includes: a conference status recording unit recording an identifier of a conference using allocated resources and a usefulness value indicating the degree of usefulness of the conference; a request accepting unit accepting a conference start request from a user; a conference opening unit instructing the multipoint connection apparatus to secure resources for use in a conference on the basis of the conference start request and recording an identifier of the conference to be started and an initial usefulness value of the conference in the conference status recording unit; and a resource releasing unit, when there are no available resources necessary for opening the conference at the time when the request accepting unit accepts the conference start request, selecting a conference, of which resources may be released, on the basis of the usefulness value of the conference, recorded in the conference status recording unit, and instructing the multipoint connection apparatus to release the resources allocated to the selected conference.

Other aspects and advantages of the embodiments of the invention discussed herein will be realized and attained by referring to the elements and combinations particularly described with reference to the accompanying drawings, wherein like numerals refer to like parts throughout, and forming a part hereof, and as pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates a view that shows the configuration of a conference system and its surrounding network according to a first embodiment;

FIG. 2 illustrates a view that shows an example of data recorded in a conference status table;

FIG. 3 illustrates a view that shows an example of data recorded in a user information table;

FIG. 4 illustrates a sequence view that shows a process in which the conference system receives a conference opening request from a user terminal to open a conference and performs monitoring;

FIG. 5 illustrates a graph that shows an example of a state in which a conference point is recorded in the conference status table and updated over time;

FIG. 6 illustrates a sequence view that shows a process of a conference system when there are no resources necessary for opening a conference;

FIG. 7 illustrates a view that shows the configuration of a conference system and its surrounding network according to a second embodiment;

FIG. 8 illustrates a graph that shows an example of a state in which a conference point is recorded in the conference status table and updated over time in the second embodiment; and

FIG. 9 illustrates a view that shows the configuration of a conference system and its surrounding network according to a third embodiment.

### DESCRIPTION OF EMBODIMENT(S)

With the below embodiment, when the conference start request is issued from the user but there are no available resources necessary for opening a conference, the resource releasing unit selects a conference, of which resources may be released, on the basis of a value indicating the degree of usefulness of the conference in the conference status recording unit. Thus, it is possible to determine, on the basis of the status of a conference, whether resources may be released. Then, the resource releasing unit instructs the multipoint connection apparatus to release resources used in a conference for which it is determined that the resources may be released. Thus, it is possible to allocate resources to the conference in connection with the conference start request. Therefore, for example, when a conference start request is issued from a user, the multipoint connection apparatus is instructed to release resources of a useless conference on the basis of the degree of usefulness of the conference, and then the resources may be allocated to a conference for which a start request is issued. As a result, resources may be effectively used, and opening a new conference is easy.

In an embodiment of the invention, a conference system may further include a monitoring unit monitoring communications in a conference using resources and updating a usefulness value indicating the degree of usefulness of the conference in accordance with a variation in the amount of information in communications of the conference.

The monitoring unit updates the degree of usefulness on the basis of the amount of information of communication data in a conference. Thus, the degree of usefulness according to the amount of information in a conference is recorded in a conference status recording unit.

In the embodiment of the invention, the monitoring unit may decrease the degree of usefulness of the conference by updating the usefulness value when a duration during which the level of audio in the conference is lower than a lower set value is a predetermined period of time or longer and may increase the degree of usefulness of the conference by updating the usefulness value when a duration during which the level of the audio is higher than an upper set value is a predetermined period of time or longer, and the resource releasing unit may select a conference, of which the degree of usefulness indicated by the usefulness value is lower than a predetermined threshold, as a conference of which resources may be released.

The monitoring unit decreases the degree of usefulness from an initial value of the degree of usefulness when a duration during which the audio level is low is a predetermined period of time or longer in the conference, and returns the degree of usefulness when a duration during which the audio level is high is a predetermined period of time or longer. Thus, the degree of usefulness is updated on the basis of the audio level of communication data in the conference. Hence, the degree of usefulness based on the audio level of participants in the conference is recorded in the conference status recording unit.

In the embodiment of the invention, the conference system may further include a user information recording unit recording user information regarding each user who can participate in a conference, the request accepting unit may accept information indicating users who participate in the conference together with the conference start request, and the conference opening unit may determine an initial usefulness value of the conference that is intended for opening by the conference start request using user information of the users who participate in the conference, the user information being recorded in the user information recording unit.

Thus, the initial usefulness value is set on the basis of the users who participate in the conference. Hence, it is possible to adjust the easiness of release of a conference when resources are insufficient on the basis of the characteristics of users who participate in the conference by, for example, the usefulness value of a conference in which a plurality of executives participate is increased to make resources difficult to release.

In the embodiment of the invention, the request accepting unit may accept data indicating the importance of a conference together with the conference start request, and the conference opening unit may determine an initial usefulness value of a conference that is intended for opening by the conference start request using the importance.

With the above configuration, a user may specify the importance of a conference when requesting start of the conference. Then, the initial usefulness value is set on the basis of the importance of the conference, specified by the user. Thus, it is possible to adjust the easiness of release of resources when resources are insufficient on the basis of the importance of a conference by, for example, making the resources of an important conference difficult to be released.

In the embodiment of the invention, the request accepting unit may accept data that indicate the importance of a conference together with the conference start request, and the monitoring unit may determine at least any one of a range of decrease when the usefulness value is updated to decrease the degree of usefulness of the conference or a range of increase when the usefulness value is updated to increase the degree of usefulness of the conference.

Thus, a range of decrease of the degree of usefulness is adjusted on the basis of the importance of a conference. That is, the easiness of release of resources of a conference when resources are insufficient is adjusted by the importance of the conference, specified by a user.

The conference system according to the embodiment of the invention may further include a close time prediction unit, when there are no available resources for opening a conference at the time when the request accepting unit accepts the conference start request, calculating a predicted close time of a conference using the usefulness value of the conference recorded in the conference status recording unit, and the request accepting unit may output the predicted close time calculated by the close time prediction unit to a user.

For example, with the above configuration, when a user requests a conference start request but there are no available resources necessary for opening a conference, the close time prediction unit calculates a predicted close time using a usefulness value, and the request accepting unit outputs the predicted close time to the user requesting to start the conference. Thus, the requesting user is able to estimate the close time of a conference. It is possible for a third person who intends to start a conference to, for example, check when resources being used in an existing conference will be released.

In the embodiment of the invention, the resource releasing unit may notify terminals participating in the conference of closing of the conference prior to releasing resources of the conference. Because the resource releasing unit notifies terminals of closing of the conference before releasing resources of the conference, participants of the conference are able to see that the conference will close.

In the embodiment of the invention, the resource releasing unit may release the resources when receiving a response, indicating that the conference may be closed, to the conference close notification from the terminals.

Thus, the resource releasing unit releases resources of a conference that may be closed. That is, this prevents resources of a conference that is not desired to close from being released.

In the embodiment of the invention, the monitoring unit may interrupt updating of the usefulness value when accepting a monitoring interruption instruction from a terminal of the conference that is using resources, and receiving the monitoring interruption instruction.

Thus, for example, during a period of time when the amount of information of communication data is temporarily small, such as during an intermission of a conference, a decrease in the degree of usefulness by updating the usefulness value is prevented by the monitoring interruption instruction from a terminal. That is, when a conference is not closed but the amount of information of communication data in the conference is small, such as during an intermission of the conference, an erroneous release of resources of the conference is prevented. Thus, for example, when it is necessary to open a conference in a state of emergency but it is difficult to constantly respond to a conference close notification that the conference cannot be released every time, it is possible to prevent resources of the conference from being forcibly released.

### First Embodiment

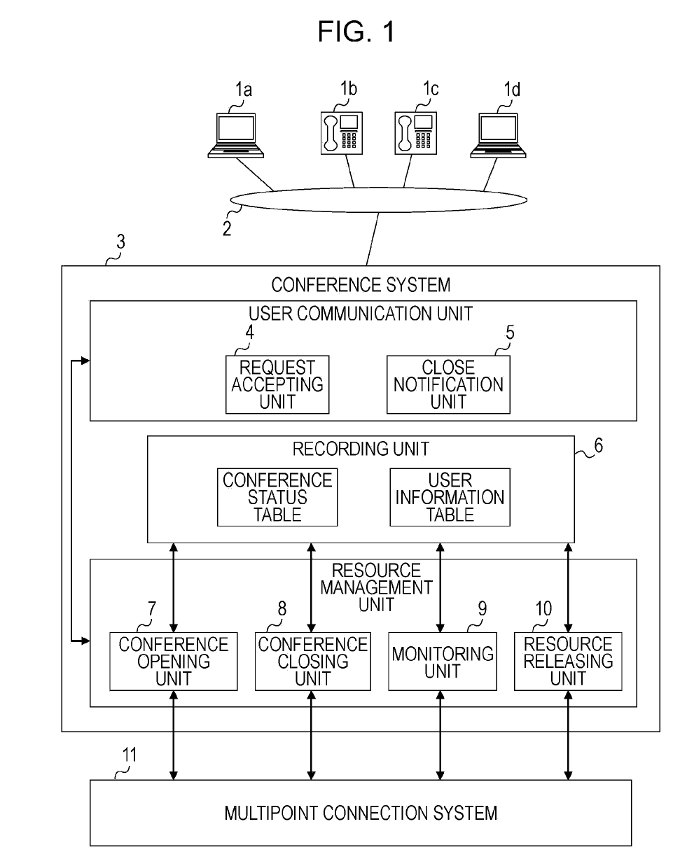

FIG. 1 is a view that shows the configuration of a conference system and its surrounding network according to a first embodiment. In the example shown in FIG. 1, the conference system 3 is connected to a multipoint connection system 11 and a network 2. Terminals 1a to 1d are connected to the network 2. The conference system 3 secures and releases resources for enabling a conference through communications among the terminals 1a to 1d.

Here, the phrase “enabling a conference” refers to enabling not only communications between two terminals but also simultaneous communications among three or more terminals. That is, the conference system 3 secures or releases resources for enabling communications not only between two terminals but also among three or more terminals. In addition, the types of data (signal) transferred through communications among the terminals 1a to 1d may include any types of data, such as video and character (text and/or image), in addition to audio and a combination of them.

In this way, the conference system 3 manages resources used in a conference. In the present embodiment, the conference system 3 outputs instructions for securing and releasing resources to the multipoint connection system 11, and then the multipoint connection system 11 secures and releases resources. Thus, among the terminals 1a to 1d in the network 2, communications among a plurality of terminals are possible.

That is, the multipoint connection system 11 is an example of the multipoint connection apparatus, and has the function of combining communication signals, including audio, of a plurality of terminals and then transmitting the combined communication signals to each of the plurality of terminals. Securing resources is to establish a state where communications among specific terminals are possible by controlling via software and/or hardware the multipoint connection system. In the present embodiment, a process of securing resources is to bring portion of the function of the multipoint connection system 11 into a state of being used for enabling communications among specific terminals.

Releasing resources are that the multipoint connection system releases the function used in communications among specific terminals. In the present embodiment, a process of releasing resources is that the multipoint connection system 11 brings the function used in communications among specific terminals into a state where the function may be used by other terminals.

The types of hardware and software in connection with securement and releasing of resources are not specifically limited. An example of securing resources includes a case in which a trunk is provided in a PBX (Private Branch Exchange) and has the function of mixing audio of a plurality of terminals, and the trunk is configured to combine audio from a desired plurality of terminals through a control of software and/or hardware. In this case, the multipoint connection system 11 is the PBX.

In addition, another example of securing resources includes a case in which a multipoint control unit (MCU), which has the function of establishing calls among a plurality of terminals connected to an IP network or a line switching network, enables communications among desired terminals. In this case, the multipoint connection system 11 is the MCU.

Note that the multipoint connection system 11 is not limited to the example of the PBX or the example of the MCU. For example, a Web conference server having the function of a combination of the multipoint connection system and the conference system may also be constructed.

Configuration of Conference System 3

The functional blocks of the conference system 3 shown in FIG. 1 are roughly separated into a user communication unit, a recording unit and a resource management unit. The user communication unit includes a request accepting unit 4 and a close notification unit 5. The recording unit 6 records therein a conference status table and a user information table. The resource management unit includes a conference opening unit 7, a conference closing unit 8, a monitoring unit 9 and a resource releasing unit 10.

The conference system 3 may be, for example, formed of a general-purpose computer, such as a personal computer or a server machine, or a conference system dedicated computer. The functions of the request accepting unit 4, close notification unit 5, conference opening unit 7, conference closing unit 8, monitoring unit 9 and resource releasing unit 10 are implemented by a predetermined program executed by the CPU of the computer. Thus, the program for implementing the above functions and a recording medium storing the program are also included in the embodiment of the invention. Note that the configuration of the conference system 3 is not limited to FIG. 1. For example, the above functional units may be distributed and configured in a plurality of computers.

The request accepting unit 4 accepts a request regarding a conference, such as a conference start request and a conference close request, from the terminals 1a to 1d. The conference start request, for example, includes, in addition to information (accounts) for identifying users who participate in a conference, participants in the conference, the importance of the conference, measures in case of insufficient resources, and other data regarding the conference to be opened. The request accepting unit 4, when receiving the conference start request, notifies the conference opening unit 7 and, when receiving the conference close request, notifies the conference closing unit 8. In addition, the request accepting unit 4 transmits a response to the accepted request to the terminals 1a to 1d.

The conference opening unit 7 receives the conference start request from the request accepting unit 4 to request the multipoint connection system 11 to secure resources for opening the conference. Moreover, the conference opening unit 7 enters information, regarding the conference opened by securing resources, in the conference status table. The conference status table includes, for example, the identifier of the opened conference, the usefulness value indicating the degree of usefulness of the conference (hereinafter, conference point), information identifying users who participate in the conference, and the like, as one record.

The conference opening unit 7 is able to determine the initial value of a conference point entered in the conference status table at the time of opening a conference on the basis of, for example, data included in the conference start request. Specifically, the conference opening unit 7 receives data indicating the importance of a conference as a conference start request and is able to determine the initial value of the conference point on the basis of the importance. Alternatively, it is also applicable that the conference opening unit 7 receives data indicating users who participate in a conference as a conference start request and acquires information regarding the users who participate in the conference from the user information table, and then determines the initial value of the conference point on the basis of the acquired information. An example of the user information includes, for example, information indicating the attribute of each user, such as user's division or user's position in relation to an entity, such as a company, or in relation to other participants. Note that similarly, it is also possible to determine the initial value on the basis of the user information of a user who issues a request for opening a conference.

The conference opening unit 7 is able to determine the initial value of the conference point of the opened conference, for example, using data, function, or the like (not shown), entered in the recording unit 6 beforehand and indicating the correspondence between the initial value of the conference point and the user information or the degree of usefulness.

Note that the conference opening unit 7 may also determine the initial value of the conference point using both the importance and the user information. In addition, the conference opening unit 7 may determine a unit of variation of the conference point used by the monitoring unit 9, which will be described later, using one or more of the importance, the user information, or any combinations thereof, and enter the unit of variation in the conference status table.

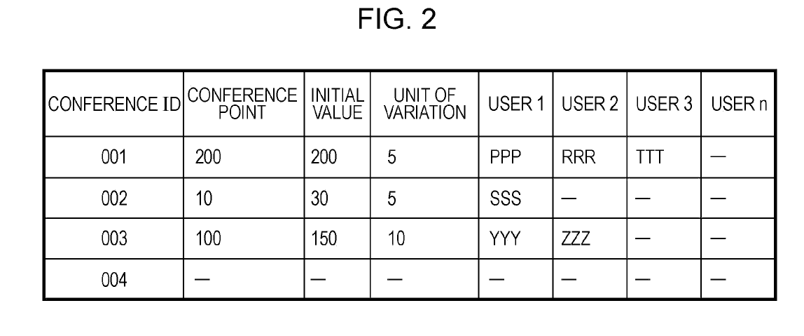

FIG. 2 is a view that shows an example of data recorded in the conference status table. In the example shown in FIG. 2, conference identifier (conference ID), conference point, initial value and unit of variation of the conference point, and accounts of users (user IDs) who participate in a conference are included as one record in association with each conference ID. The initial value determined by the conference opening unit 7 at the time of opening a conference is recorded in the conference point of the conference status table and, after that, during the conference, the value is updated on the basis of the status of the conference by the monitoring unit 9, which will be described later.

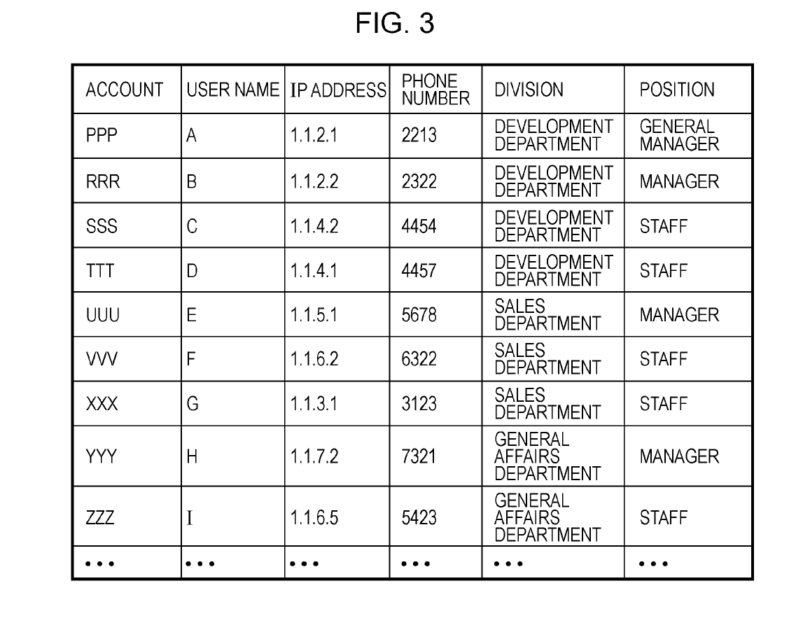

FIG. 3 is a view that shows an example of data recorded in the user information table. In the example shown in FIG. 3, account (user ID), user name, IP address, phone number, division and position in a company are recorded for each account. The user information table is recorded in the recording unit 6 beforehand and is updated by a user as needed.

The monitoring unit 9 monitors communication traffic among a plurality of terminals connected by the multipoint connection system 11 in accordance with an instruction for securing resources of a conference from the conference opening unit 7. For example, the monitoring unit 9 periodically measures communication traffic in each of the conferences that use secured resources. That is, the amount of traffic (amount of information) in communications in each conference is measured. The measured result is converted into a value indicating the status of use (the degree of usefulness) of the conference system in each conference and is used as an addition value or a subtraction value to the conference point. Thus, each conference point becomes a value in consideration of the status of use of the conference system.

Specifically, when a duration during which the amount of traffic in a conference is lower than a set value SL reaches a predetermined period of time T1, the monitoring unit 9 determines that the usage of the conference is reduced and then is able to reduce the conference point in the conference status table by a predetermined amount RL. Furthermore, when a duration during which the amount of traffic in a conference is higher than a set value SU reaches a predetermined period of time T2, the monitoring unit 9 determines that the usage of the conference is increased and then is able to increase the conference point by a predetermined amount RU.

Note that the monitoring unit 9 may change a conference point using the initial value recorded in the conference status table as an upper limit of the conference point. By so doing, it is possible to avoid a situation that the conference point falls outside a valid value indicating the degree of usefulness of the conference. For example, it is possible to avoid a situation that the conference point is excessively high and then a duration during which the amount of traffic is small is long; however, the conference point is not reduced to a predetermined value or below.

In addition, the reference values, such as the set values SL and SU, the predetermined periods of time T1 and T2, and the predetermined amount RU, used as a reference for determination, may be preset fixed values. Alternatively, as described above, at the time of opening a conference, the conference opening unit 7 may determine the above reference values using the importance of the conference and/or the user information of users who participate in the conference and record the reference values in the recording unit 6.

Here, the value indicating the amount of traffic, measured by the monitoring unit 9, may be, for example, set to an audio level. Thus, for example, when a silent interval continues for a predetermined period of time, it is determined that the usage of a conference is reduced, and the degree of usefulness of the conference may be decreased. Note that the monitoring unit 9 may measure, for example, the amount of data, or the like, terminals exchange for using an application (for example, white board, text chat, or the like) provided by the conference system as the amount of traffic, in addition to the audio level.

The resource releasing unit 10, when there are no available resources necessary for the conference at the time when the request accepting unit 4 accepts a conference start request, extracts a conference, of which resources may be released, and makes the extracted conference release the resources used therein. The resource releasing unit 10 is able to determine, on the basis of, for example, the value of a conference point in the conference status table, whether resources used in respective conferences may be released. As an example, the resource releasing unit 10 extracts the conference ID of which the conference point is lower than a threshold A in the conference status table. Then, the resource releasing unit 10 notifies the extracted conference ID to the multipoint connection system 11 to request the multipoint connection system 11 to release resources of the conference. The threshold A may also be a preset fixed value or may be determined for each conference on the basis of the importance of the conference, user information, and the like.

In addition, the resource releasing unit 10, when releasing the resources of the conference, requests the close notification unit 5 to notify the terminals of the users who use the conference of the closing of the conference. The close notification unit 5 notifies the terminals of the users who use the conference of the closing of the conference. Thus, before the resource releasing unit 10 releases resources to cause the conference to close, it is possible to confirm users whether the conference may be closed.

Owing to the function of the resource releasing unit 10, when there are no available resources necessary for opening a conference at the time when a user requests for opening the conference, it is possible to release the resources of the conference of which the degree of usefulness is low and then allocate the resources to the conference requested by the user.

In this way, the resource releasing unit 10 releases resources by closing another conference of which the usefulness is low in order to secure resources when resources are insufficient. On the other hand, the conference closing unit 8, when the request accepting unit 4 receives a conference close request from the terminal of a user in conference, receives the conference close request to cause the conference to close.

The conference close request accepted by the request accepting unit 4, for example, includes the conference ID of the conference for which the closing is requested. The conference closing unit 8 requests the multipoint connection system 11 to release the resources of the conference indicated by the conference close request received from the request accepting unit 4. Furthermore, the conference opening unit 7 updates data of the conference status table and reflects the release of the resources of the conference in the conference status table.

Operation Example of Conference System 3

Operation Example of Conference Opening, Monitoring and Conference Closing

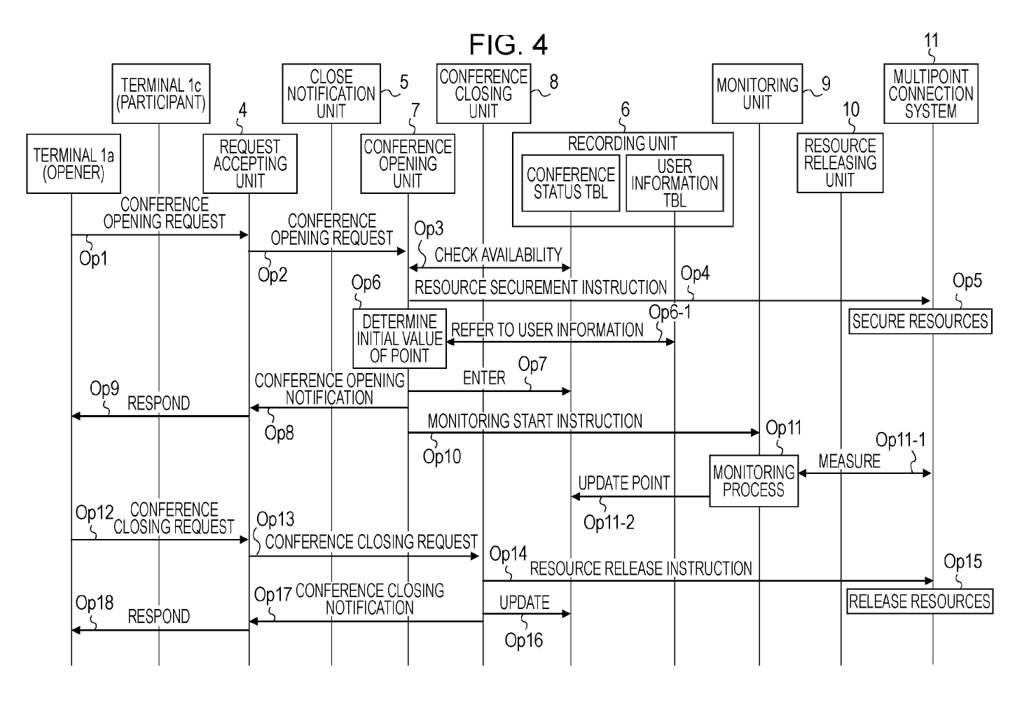

FIG. 4 is a sequence view that shows a process in which the conference system receives a conference opening request from a user terminal to open a conference and performs monitoring. The example shown in FIG. 4 shows a process when, at the time of receiving a conference start request, there are available resources necessary for a conference and opening the conference is possible.

Open Conference

First, the request accepting unit 4 receives a conference start request from the terminal 1a (Op1). The request accepting unit 4 notifies the conference opening unit 7 of the conference start request (Op2). As an example, it is assumed that the conference start request includes accounts (user IDs) by which users who participate in the conference are identified and the importance of the conference.

The conference opening unit 7 refers to the conference status table to check whether there are available resources for opening the conference (Op3). For example, as in the case of the record of the conference ID=“004”, shown in the conference status table in FIG. 2, when there is a record of which the conference point indicates no data “−”, the conference opening unit 7 determines that there are available resources and then acquires the conference ID “004”.

When the conference opening unit 7 determines that there are available resources, the conference opening unit 7 instructs the multipoint connection system 11 to secure resources for the conference in connection with the conference start request (Op4). At that time, for example, the multipoint connection system 11 is also notified of necessary data, such as the conference ID “004” and data that specify the terminals of participating users (for example, IP addresses). Receiving the instruction, the multipoint connection system 11 secures resources (Op5). Thus, communications among the terminals of the users who participate in the conference are enabled, and the conference is opened.

Moreover, the conference opening unit 7 calculates the initial value and unit of variation of the conference point of the opened conference (Op6). For example, the initial value is determined on the basis of the user information of the users who participate in the conference and the importance.

The conference opening unit 7 temporarily determines the initial value based on the importance included in the conference start request. For example, when the importance is indicated on three levels A, B and C, it is temporarily determined that, for example, the initial value=“150” in the case of A, the initial value=“100” in the case of B, and the initial value=“50” in the case of C. Next, the conference opening unit 7 refers to the user information table to acquire the positions of the participating users (Op6-1). Then, the conference opening unit 7 is able to obtain an ultimate initial value by adding numbers corresponding to the acquired positions to the temporarily determined initial value. The conference opening unit 7, for example, may add “50” when the position is “general manager”, add “20” for “manager”, and add “5” for “staff”.

In addition, similarly, the conference opening unit 7 is also able to determine the unit of variation of a conference point using one or more of the user information, the importance, or any combination thereof. The thus determined initial value and unit of variation of the conference point are entered in the record of the conference ID=“004” in the conference status table together with the accounts of the participating users (Op7). Here, as an example, the case in which the initial value=“200” and the unit of variation=“10” are entered in the conference status table will be described below.

When the entry into the conference status table is complete, the conference opening unit 7 notifies the request accepting unit 4 of completion of opening the conference (Op8), and the request accepting unit 4 responds to the terminal 1a that opening the conference is complete (Op9). At the time of the response, for example, the terminal 1a may be notified of data regarding the opened conference, such as the conference ID “004” of the opened conference. Thus, for example, a user who desires to participate in the conference after it has been opened is able to participate in the conference by transmitting a conference participation request including the conference ID “004” to the conference system 3 through a terminal.

Furthermore, the conference opening unit 7 instructs the monitoring unit 9 to start monitoring the opened conference (Op10). At the time of the instruction, the monitoring unit 9 is, for example, notified of the conference ID “004” of the opened conference. The monitoring unit 9 starts monitoring the conference of the conference ID=“004” (Op11).

Monitoring

The monitoring unit 9, for example, periodically measures the audio level (e.g., amount of audio communication, sound level, or any combination thereof) in data communicated in the conference of the conference ID=“004” (Op11-1). Then, the monitoring unit 9 updates the conference point in the record of the conference ID=“004” in the conference status table in accordance with the measured result (Op11-2).

For example, when the audio level that is lower than the set value SL is measured N times in a row, the monitoring unit 9 updates the conference point “200” in the record of the conference ID=“004” in the conference status table to a value “190”, for which the unit of variation “10” is subtracted from “200”. Conversely, when the audio level that is higher than the set value SU is measured N times in a row, the monitoring unit 9 updates the conference point “190” to a value “200”, for which the unit of variation “10” is added to “190”. In addition, when the conference point is “200” (equal to the initial value”), the monitoring unit 9 may be configured not to increase the conference point to above “200” even when the audio level that is higher than the set value SU is measured N times in a row.

Through the above monitoring process, as the silent interval, in which audio interrupts during a conference, continues, the conference point indicating the usefulness of the conference is updated to decrease. That is, the status of the conference is reflected in the conference point in the conference status table.

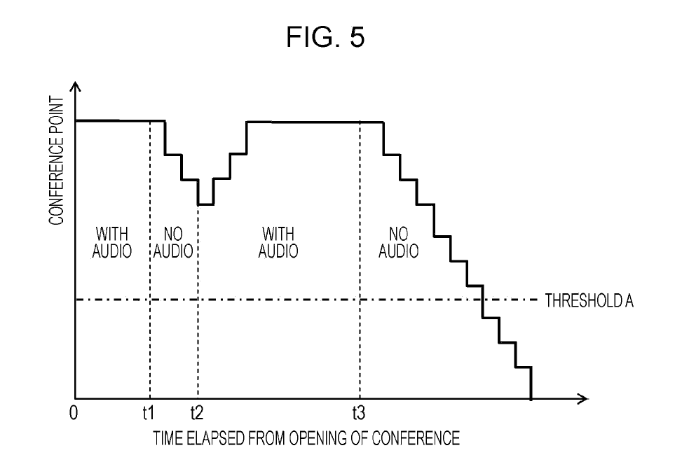

FIG. 5 is a graph that shows an example of a state in which the conference point is recorded in the conference status table and updated over time. In the graph shown in FIG. 5, the ordinate axis represents a conference point, and the abscissa axis represents time elapsed from the opening of a conference. In the example of this graph, the conference point does not decrease during the interval (0 to t1) in which the audio level is equal to or higher than a predetermined level (with audio), and the conference point decreases over time during the interval (t1 to t2) (no audio). When it becomes a situation with audio again, the conference point returns to the initial value. After that, when audio loses at t3, the conference point continues to decrease, falls below the threshold A and finally reaches 0.

Close Conference

The user of the terminal 1a by which the conference is opened, when closing the conference, transmits a conference close request to the request accepting unit 4 through the terminal 1a (Op12). The conference close request, for example, includes data for identifying the conference intended for closing (here, for example, conference ID “004”). The request accepting unit 4 notifies the conference closing unit 8 of the conference close request (Op13). The conference closing unit 8 instructs the multipoint connection system 11 to release the resources used in the conference of the conference ID=“004” (Op14). Thus, the resources used in the conference of the conference ID=“004” are released (Op15).

The conference closing unit 8, when instructing to release the resources in Op14, updates the record in the conference status table indicating that the conference, of which the resources are released, is not using the resources (Op16). For example, the conference closing unit 8 updates the data of the conference point, initial value, unit of variation and users in the record of the conference ID=“004”, of which the resources are released, to no data “−”.

Furthermore, the conference closing unit 8 notifies the request accepting unit 4 that releasing the resources is complete and the conference is closed (Op17). The request accepting unit 4 responds to the terminal 1a that closing the conference is complete (Op₁₈).

Operation Example of Case Where Resources Are Released to Open Conference

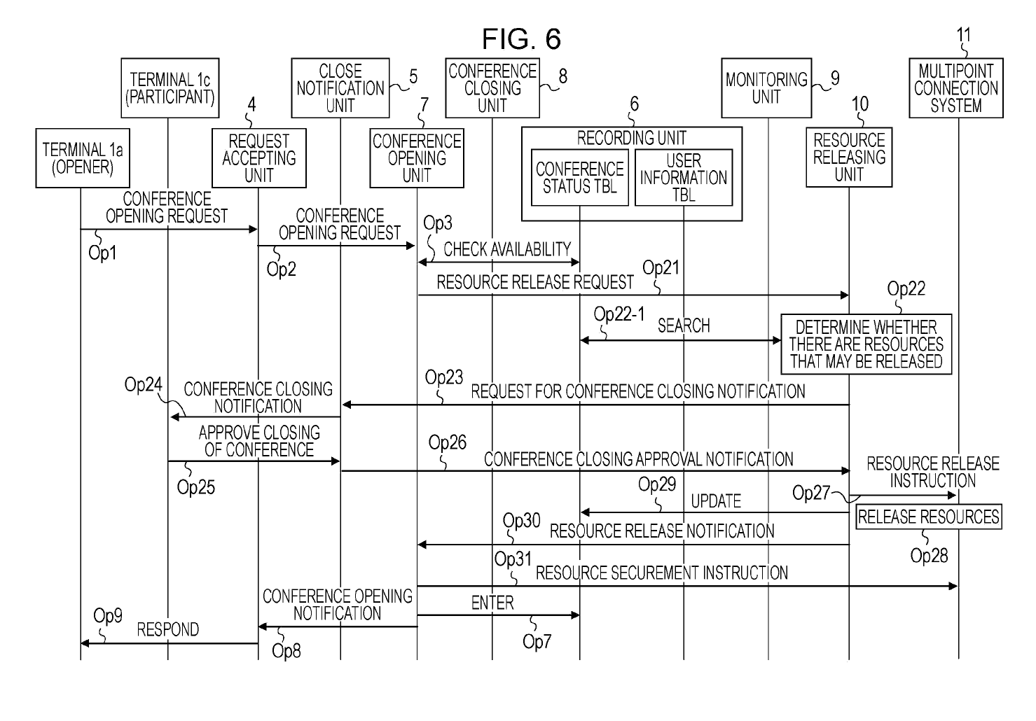

Next, an operation example of the conference system 3 when a conference start request is received but there are no available resources necessary for opening a conference will be described. FIG. 6 is a sequence view that shows a process of the conference system 3 in this case.

The process of accepting the conference start request in Op1 and Op2 in FIG. 6 is similar to that of Op1 and Op2 in FIG. 4. The operation example shown in FIG. 6 is the operation example of the conference system 3 when, in Op3, the conference opening unit 7 refers to the conference status table and, as a result of checking for available resources, determines that there are no available resources necessary for opening the conference.

In this case, the conference opening unit 7 requests the resource releasing unit 10 to release resources that may be released among the resources being used (Op21). The resource releasing unit 10 determines whether there are resources that may be released among the resources being used in the conferences (Op22). Specifically, the resource releasing unit 10 searches the conference status table in the recording unit 6 for a record of which the conference point is lower than the threshold A (Op22-1). For example, when the threshold A=30 and the conference point in the record of the conference ID=“004” in the conference status table is “25”, the resource releasing unit 10 acquires the conference ID “004” as data indicating the conference of which the resources may be released.

Here, the threshold A may be a predetermined fixed value. Alternatively, the conference start request accepted by the request accepting unit 4 in Op1 may include the threshold A. In this case, the user who issues a request for opening the conference is able to specify the threshold A. Alternatively, the threshold A may be determined on the basis of the importance of the conference included in the conference start request and/or the user information. For example, the resource releasing unit 10 may calculate the threshold A so that the higher the importance of the conference is, the higher the threshold A is. In addition, the threshold A may be calculated on the basis of the attribute of a user who intends to open the conference, the attributes and number of participating users, or the like. For example, when the participating users include “general manager”, calculation may be such that the threshold A is increased by “5”, or the like. Thus, it is possible to control the priority of a conference on the basis of the importance of the conference and the users.

Hereinafter, as an example, the case in which, in Op22, the resource releasing unit 10 determines that the resources of the conference of the conference ID=“004” may be released will be described. In this case, the resource releasing unit 10 requests the close notification unit 5 to notify the terminals of the users, participating in the conference of the conference ID=“004”, of a conference closing guidance (Op23). At the time of the request, the resource releasing unit 10 refers to the conference status table and the user information table to acquire, for example, the IP addresses of the users participating in the conference ID=“004” and then notifies the close notification unit 5 of the acquired IP addresses.

The close notification unit 5 notifies the terminal (terminal 1c) at the notified IP address of the conference closing guidance (Op24). Thus, the terminals of the users participating in the conference are notified of the conference closing guidance. Here, the content of the conference closing guidance may be a request to the users for a response of information indicating whether the conference may be closed or may be just a notification to the users that the conference will be closed. By notifying the users of the guidance requiring a response, it is possible to prevent the conference from being closed against users' intention. By notifying the users of the guidance just indicating the closing of the conference, it is not necessary to wait users' response and, therefore, it is possible to quickly release the resources.

Here, the case in which the terminal 1b of the user participating in the conference responds to the close notification unit 5 that the closing of the conference is approved (Op25) will be described. The close notification unit 5 notifies the resource releasing unit 10 of the approval on closing of the conference (Op26). The resource releasing unit 10, when receiving the approval on closing of the conference, instructs the multipoint connection system 11 to release the resources being used in that conference (Op27). Thus, the resources are released (Op28). At this time, the resource releasing unit 10 notifies the multipoint connection system 11 of the conference ID “004” of the conference that is using the resources desired to be released, thus making it possible to specify the resources to be released.

Note that the resource releasing unit 10 may release resources when a predetermined period of time has elapsed since the terminal 1b is notified of the closing of the conference instead of receiving a notification of approval on closing of the conference. When no response is received from the terminal 1b for a predetermined period of time, it may be regarded that the conference is substantially not conducted. In addition, the resource releasing unit 10 may wait for a response to the conference close notification from all the terminals of the users participating in the conference or may wait for a response from a portion of the terminals.

The resource releasing unit 10, when issuing an instruction for releasing the resources in Op27, updates the record in the conference status table indicating that the conference, of which the resources are released, is not using the resources (Op29). For example, the resource releasing unit 10 updates the data of the conference point, initial value, unit of variation and users in the record of the conference ID=“004”, of which the resources are released, to no data “−”.

Furthermore, the resource releasing unit 10 notifies the conference opening unit 7 that releasing the resources is complete (Op30). This is a response to the resource releasing request in Op21. At this time, the resource releasing unit 10 notifies the conference opening unit 7 of, for example, the conference ID “004” indicating the conference of which the resources are released.

The conference opening unit 7, when receiving the response of completion of releasing the resources, instructs the multipoint connection system 11 to secure the released resources in order to open a new conference (Op31). The following operations for opening the conference are similar to the operation in Op7 and the following operations shown in FIG. 4.

Through the operation example shown in FIG. 6, the conference system, when receiving a request from a third person who intends to open a new conference in a state where resources necessary for opening a conference run out, is able to extract a conference of which the resources may be released without problems. That is, the conference system is able to release the resources of a conference in which communications among the terminals are substantially not performed and may be closed without any problems. As a result, it is possible to allocate the resources to a new conference.

For example, there is a case where an already opened conference is left as it is after communications are finished and then the resources remain secured, or a case where resources are constantly secured to intentionally not release the resources in order for a user who frequently opens a conference to save time for opening the conference. The conference system 3 is able to determine such a conference as a conference, of which the resources may be released without any problems, to close the conference and release the resources, and then allocate the released resources for opening a conference for which a third person issues a start request.

Furthermore, the conference system 3, in regard to a conference for which it is determined that the resources may be released without any problems, notifies a user who opened the conference or users participating in the conference of the closing of the conference. Thus, the conference system 3 is able to determine that the resources may be released and obtain confirmation or approval of users' intention, and then close the conference.

In this way, in the conference system 3 of the present embodiment, in response to a conference start request at the time when resources for a conference run out, by selecting or releasing resources on which both users using the resources and a user who conducts a new open request reach agreement, a smooth operation of the system is achieved.

Note that the embodiment of the invention is not limited to the above. For example, the request accepting unit 4 may receive a conference start request that includes a conference ID specified by a user. In this case, the conference opening unit 7 refers to the conference status table to check whether the resources of the conference ID that is received together with the conference start request are available (whether the resources are used). Then, when the resources are being used, the resource releasing unit 10, as in the case of FIG. 6, determines whether the resources may be released on the conference that is using the resources. When it is determined that the resources may be released, the resources are released and then allocated to a conference for which a conference start request is issued.

In addition, in the example shown in FIG. 6, the resource releasing unit 10 transmits a close notification to the users for the conference that is determined so that the resources may be released; instead, it is also applicable that a close notification is not transmitted and the conference is forcibly closed. By so doing, it is possible to further quickly secure the resources.

### Second Embodiment

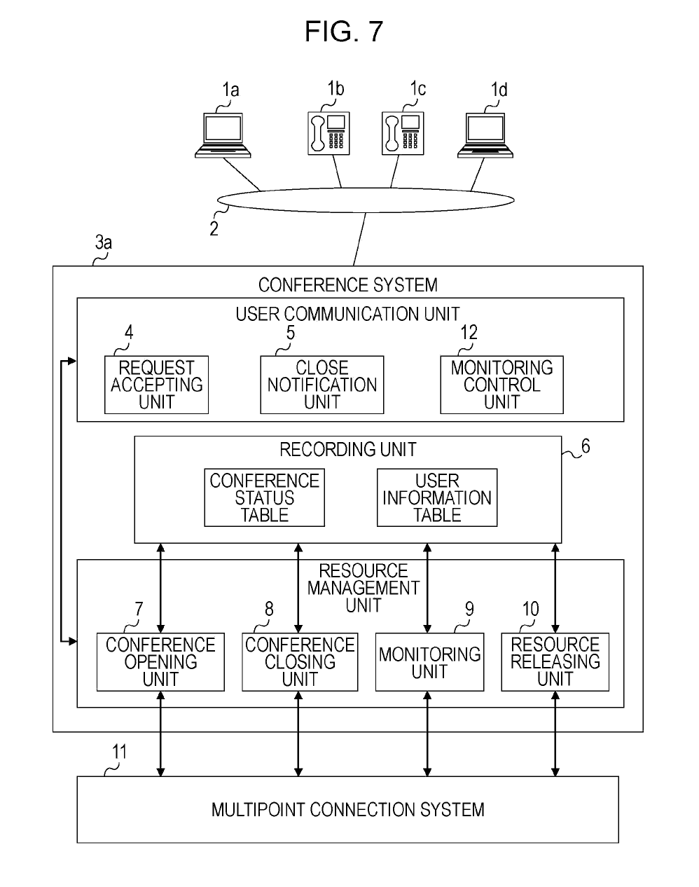

FIG. 7 is a view that shows the configuration of a conference system and its surrounding network according to a second embodiment. In FIG. 7, like reference numerals denote like functional blocks to those of FIG. 1. In the present embodiment, the conference system 3a further includes a monitoring control unit 12 in the user communication unit. The monitoring control unit 12 controls monitoring of a conference by the monitoring unit 9 in accordance with an instruction from the terminals of the users in conference. The monitoring control unit 12 receives, for example, data, instructing the monitoring unit 9 to stop or resume monitoring a specific conference, from the terminals of the users participating in the specific conference. The monitoring control unit 12 controls the monitoring unit 9 on the basis of the received data.

Specifically, the monitoring control unit 12, when receiving a monitoring stop instruction from the terminal of a user participating in the conference of the conference ID=“001”, updates “unit of variation” (unit of variation of the conference point) in the record of the conference ID=“001” in the conference status table from “5” to “0” (see FIG. 2). Thus, even when the monitoring unit 9 executes a process of adding or subtracting the conference point on the conference of the conference ID=“001”, the conference point does not change. Thus, the result of monitoring by the monitoring unit 9 is not reflected in the conference point, and monitoring is substantially stopped.

The monitoring control unit 12, when receiving a monitoring resume instruction, returns the “unit of variation” in the conference status table from “0” to “5” to substantially resume monitoring. Note that a method of controlling monitoring is not limited to the method by updating the conference status table as in the above example; for example, a method of directly controlling the operation of the monitoring unit 9 may also be employed.

In addition, the content of control is also not limited to stopping and resuming of monitoring. For example, the monitoring control unit 12 is able to adjust the degree of the unit of variation of the conference point on the basis of the result of monitoring by updating the “unit of variation” in the conference status table (for example, updating from “5” to “3”) in accordance with an instruction from a terminal. In addition, the monitoring control unit 12 may receive a specified conference point of a conference from the terminal of a user participating in the conference to update the conference point in the conference status table to the specified conference point.

According to the present embodiment, users participating in a conference may control monitoring on the conference depending on the status of the conference. Thus, while a conference is being interrupted because of, for example, an intermission, users are able to issue an instruction for stopping monitoring on the conference. Hence, during an intermission, it is possible to prevent a situation that the monitoring unit 9 reduces the conference point and then it is determined that the conference is substantially not opened to thereby release the resources.

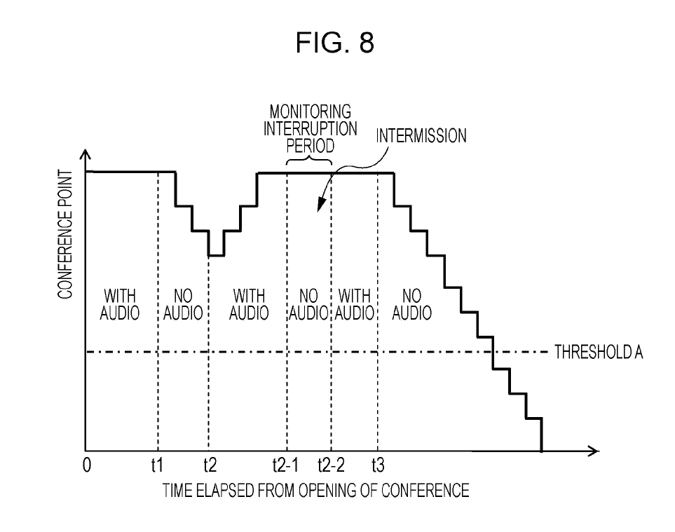

FIG. 8 is a graph that shows an example of a state in which a conference point is recorded in the conference status table and updated over time in the present embodiment. In the example shown in FIG. 8, it is an intermission from time t2-1 to time t1-2, and a user instructs the monitoring control unit 12 to stop monitoring on the conference during the interval. Between time t2-1 and t2-2, it is an interval with no audio; however, the conference point does not decrease.

### Third Embodiment

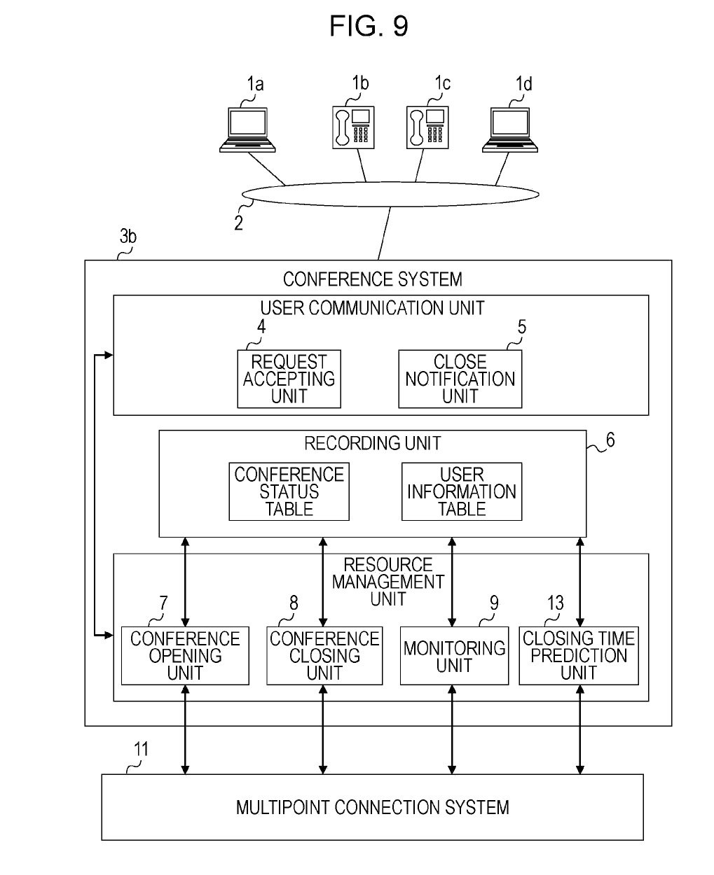

FIG. 9 is a view that shows the configuration of a conference system and its surrounding network according to a third embodiment. In FIG. 9, like reference numerals denote like functional blocks to those of FIG. 1. In the present embodiment, the conference system 3b includes a closing time prediction unit 13 instead of the resource releasing unit 10.

In the present embodiment, as in the case of the first embodiment, the request accepting unit 4 accepts a conference start request from the user terminals 1a to 1d. The request accepting unit 4 notifies the conference opening unit 7 of the conference start request. The conference opening unit 7, when there are no available resources for opening a conference of the conference start request, requests the closing time prediction unit 13 to calculate closing time periods of the conferences using the resources. The closing time prediction unit 13, when receiving the request, refers to the conference status table, acquires the conference points of the conferences using the resources, and then calculates the closing periods of time using the acquired conference points and the unit of variation of each conference point.

As an example, the closing time prediction unit 13 is able to calculate a closing period of time TEND (period of time from the current time until the conference is closed) using the conference point P and the unit of variation U of the conference point through the following Expression (1).

TEND=P/(TC×U) (1)

In Expression (1), TC denotes a constant and is, for example, determined on the basis of a period at which the conference point is updated by the monitoring unit 9.

Note that the closing time prediction unit 13, when the conference start request includes the conference ID, is able to calculate the closing period of time of the conference of that conference ID and provides the closing period of time to the conference opening unit 7 as a response. When no conference ID is included in the conference start request, the closing time prediction unit 13 is able to calculate the closing periods of time of all the conferences using the resources and then provides, for example, the shortest closing period of time among them to the conference opening unit 7 as a response.

Thus, the conference opening unit 7 provides a closing time period to the request accepting unit 4 as a response, and the request accepting unit 4 provides the closing time period to the terminal, from which the conference start request is transmitted, as a response. Hence, the user of the terminal from which the conference start request is transmitted is able to estimate a time at which the conference may be opened.

Note that in the above embodiment, the closing time prediction unit 13 is provided instead of the resource releasing unit 10; instead, the closing time prediction unit 13 may be provided in addition to the resource releasing unit 10. In this case, for example, in the process of releasing resources of the resource releasing unit 10, when resources cannot be released because of no conferences of which the resources may be released, the closing time prediction unit 13 may calculate the closing periods of time of the conferences.

According to the conference system disclosed in the application, it is possible to effectively use resources and easily open a new conference.

According to an aspect of the embodiments of the invention, any combinations of the described features, functions, operations, and/or benefits can be provided. The embodiments can be implemented as an apparatus (a machine) that includes computing hardware (i.e., computing apparatus), such as (in a non-limiting example) any computer that can store, retrieve, process and/or output data and/or communicate (network) with other computers. According to an aspect of an embodiment, the described features, functions, operations, and/or benefits can be implemented by and/or use computing hardware and/or software. The apparatus (e.g., the terminal 1, the conference system 3, the multipoint connection system 11, etc.) comprises a controller (CPU) (e.g., a hardware logic circuitry based computer processor that processes or executes instructions, namely software/program), computer readable recording media, transmission communication media interface (network interface), and/or a display device, all in communication through a data communication bus. The results produced can be displayed on the display. A program/software implementing the embodiments may be recorded on computer computer-readable recording media. Examples of the computer-readable recording media include a magnetic recording apparatus, an optical disk, a magneto-optical disk, and/or semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), DVD-ROM, DVD-RAM (DVD-Random Access Memory), BD (Blue-ray Disk), a CD-ROM (Compact Disc-Read Only Memory), and a CD-R (Recordable)/RW.

The program/software implementing the embodiments may also be included/encoded as a data signal and transmitted over transmission communication media. A data signal moves on transmission communication media, such as the wired network or the wireless network, for example, by being incorporated in a carrier wave. However, the data signal may be transferred not by the carrier wave described above but as a so-called baseband signal. Such a carrier wave is transmitted in an electrical, magnetic or electromagnetic form, or an optical, acoustic or any other form.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A conference system that allocates resources of a multipoint connection apparatus, having a function of combining communication signals including audio of a plurality of terminals and transmitting the combined communication signals to each of the plurality of terminals, to each conference through communications of a plurality of user terminals, the conference system comprising:
a conference status recording unit recording an identifier of an open conference using allocated resources and a usefulness value indicating a degree of usefulness of the open conference;
a request accepting unit accepting a conference start request from the user;
a conference opening unit instructing the multipoint connection apparatus to secure resources for use in a conference based upon the conference start request and recording an identifier and an initial usefulness value of the conference to be started in the conference status recording unit; and
a resource releasing unit, when there are no available resources for opening the conference when the request accepting unit accepts the conference start request, selecting other open conference, of which resources may be released, based upon the usefulness value of the other open conference, recorded in the conference status recording unit, and instructing the multipoint connection apparatus to release the resources allocated to the selected other open conference.

2. The conference system according to claim 1, further comprising:
a monitoring unit monitoring communications in the open conference using resources and updating the usefulness value indicating the degree of usefulness of the open conference in accordance with a variation in an amount of information in communications of the open conference.

3. The conference system according to claim 2, wherein
the monitoring unit decreases the degree of usefulness of the open conference by updating the usefulness value when a duration during which a level of audio in the open conference is lower than a lower set value is a predetermined period of time or longer and increases the degree of usefulness of the conference by updating the usefulness value when a duration during which the level of the audio is higher than an upper set value is a predetermined period of time or longer, and wherein
the resource releasing unit selects the open conference, of which the degree of usefulness indicated by the usefulness value is lower than a predetermined threshold, as the other open conference of which resources may be released.

4. The conference system according to any one of claims 1 to 3, further comprising:
a user information recording unit recording user information regarding each user who can participate in a conference, wherein
the request accepting unit accepts information indicating users who participate in the conference together with the conference start request, and wherein
the conference opening unit determines an initial usefulness value of the conference that is intended for opening by the conference start request using the user information of the users who participate in the conference.

5. The conference system according to any one of claims 1 to 3, wherein
the request accepting unit accepts data indicating an importance of a conference together with the conference start request, and wherein
the conference opening unit determines an initial usefulness value of a conference that is intended for opening by the conference start request using the importance.

6. The conference system according to claim 3, wherein
the request accepting unit accepts data indicating the importance of a conference together with the conference start request, and wherein
the monitoring unit determines one or more of a range of decrease when the usefulness value is updated to decrease the degree of usefulness of the open conference, or a range of increase when the usefulness value is updated to increase the degree of usefulness of the open conference, or any combination thereof.

7. The conference system according to any one of claims 1 to 3, further comprising:
a close time prediction unit, when there are no available resources for opening a conference when the request accepting unit accepts the conference start request, calculating a predicted close time of the other open conference using the usefulness value of the other open conference recorded in the conference status recording unit, wherein
the request accepting unit outputs the predicted close time calculated by the close time prediction unit to the conference start request user.

8. The conference system according to any one of claims 1 to 3, wherein the resource releasing unit notifies terminals participating in the other open conference of closing of the other open conference prior to releasing resources of the other open conference.

9. The conference system according to claim 8, wherein the resource releasing unit releases the resources of the other open conference when the conference close notification receives a response, indicating that the other open conference may be closed, from the other open conference.

10. The conference system according to claim 2, wherein the monitoring unit interrupts updating of the usefulness value when accepting a monitoring interruption instruction from a terminal of the open conference that is using resources.

11. A method of allocating conference resources of a multipoint connection apparatus, having a function of combining communication signals including audio of a plurality of terminals and transmitting the combined communication signals to each of the plurality of terminals, to each conference through communications of a plurality of user terminals, the method comprising:
storing an identifier of an open conference using allocated resources and a usefulness value indicating a degree of usefulness of the open conference;
accepting a conference start request from the user;
instructing the multipoint connection apparatus to secure resources for use in a conference based upon the conference start request and storing an identifier and an initial usefulness value of the conference to be started; and
when there are no available resources for opening the conference at a time of accepting the conference start request, selecting other open conference, of which resources may be released, based upon the stored usefulness value of the other conference, and instructing the multipoint connection apparatus to release the resources allocated to the selected other open conference.

12. A computer-readable storage medium storing a conference program that controls a computer to allocate resources of a multipoint connection apparatus, having a function of combining communication signals including audio of a plurality of terminals and transmitting the combined communication signals to each of the plurality of terminals, to each conference through communications of a plurality of user terminals, the conference program causes the computer to execute:
recording an identifier of an open conference using allocated resources and a usefulness value indicating a degree of usefulness of the open conference;
accepting a conference start request from the user;
instructing the multipoint connection apparatus to secure resources for use in a conference based upon the conference start request and recording an identifier and an initial usefulness value of the conference to be started; and
when there are no available resources for opening the conference at a time of accepting the conference start request, selecting other open conference, of which resources may be released, based upon the stored usefulness value of the other conference, and instructing the multipoint connection apparatus to release the resources allocated to the selected other open conference.

13. The method according to claim 11, further comprising setting and/or updating the usefulness value of the open conference according to one or more of a variation in an amount of communication information in the open conference, conference participant information, conference participant request, conference priority, or any combinations thereof.
